(19) United States
(12) Patent Application Publication
(10) Pub. No.: US 2006/0029890 A1
(43) Pub. Date: Feb. 9, 2006

(54) Lens formation by pattern transfer of a photoresist profile

(75) Inventors: Bruce D. Ulrich, Beaverton, OR (US); Yoshi Ono, Camas, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/916,810

(22) Filed: Aug. 9, 2004

(51) Int. Cl. G02B 3/00

(52) U.S. Cl. 430/321

(57) ABSTRACT

A methods of forming a microlens structure are provided. An embodiment of the method comprises exposing a photoresist layer a predetermined focus and exposure to sensitize a lens-shaped region within the photoresist layer. The photoresist layer is then developed to form a lens-shaped region within the photoresist layer. The lens-shaped region may then be transferred to an underlying material. The underlying material may be a transparent material within which a lens is subsequently formed. Alternatively, the underlying material is a lens material that will form the microlens once the lens-shaped region is transferred.

### BACKGROUND OF THE INVENTION

The present method relates to methods of forming microlens structures on a substrate.

Increasing the resolution of image sensors requires decreasing pixel size. Decreasing pixel size reduces the photoactive area of each pixel, which can reduce the amount of light sensed by each pixel.

Positioning a microlens above each pixel may be used to increase the amount of light impinging on each pixel thereby increasing the effective signal for each pixel.

### BRIEF DESCRIPTION OF THE DRAWINGS

FIG. 1 is a cross sectional view of a microlens structure overlying a substrate.

FIG. 2 is a cross-sectional view of an intermediate microlens structure overlying a substrate.

FIG. 3 is a cross-sectional view of an intermediate microlens structure overlying a substrate.

FIG. 4 is a cross-sectional view of an intermediate microlens structure overlying a substrate.

FIG. 5 is a cross-sectional view of an intermediate microlens structure overlying a substrate.

FIG. 6 is a cross-sectional view of an intermediate microlens structure overlying a substrate.

FIG. 7 is a cross-sectional view of a microlens structure overlying a substrate.

FIG. 8 is a cross-sectional view of an intermediate microlens structure overlying a substrate.

FIG. 9 is a cross-sectional view of an intermediate microlens structure overlying a substrate.

FIG. 10 is a cross-sectional view of a microlens structure overlying a substrate.

FIG. 11 is a cross-sectional view of a microlens structure overlying a substrate.

FIG. 12 shows photoresist profiles.

FIG. 13 is a Focus-Exposure matrix.

FIG. 14 shows photoresist profiles compared to parabolic curves.

### DETAILED DESCRIPTION OF THE INVENTION

Accordingly, a method is provided to form a microlens to increase the light impinging on each pixel of an active photodetector device. If the microlens is fabricated properly to provide the proper shape and position, the microlens will direct light impinging on the lens onto the photodetector pixel. If the microlens has an area larger than the pixel area, it can collect light that would normally impinge on the areas outside each individual pixel and direct the light onto the photodetector pixel. Increasing the amount of light impinging on the photodetector pixel will correspondingly increase the electrical signal produced by the pixel.

FIG. 1 shows an embodiment of a microlens structure formed according to an embodiment of the present method. A substrate 10 has at least one photo-element 12 formed thereon. The photo-elements 12 may be photosensitive elements, for example CCD camera pixels; or photodisplay elements, for example LCD pixels. A transparent layer 14 has been deposited overlying the substrate 10. A microlens 20 is formed above a photo-element 12. The microlens 20 is an approximately plano-convex lens with the convex surface directed towards the photo-element 12. The thickness of the transparent layer 14 will be determined, in part, based on the desired lens curvature and focal length considerations. While having light impinge on the planar surface first, instead of the convex surface, increases known aberrations, this is less critical in the present application, which is concerned with increasing the amount of light impinging on each photo-element 12, rather than trying to clearly focus an image.

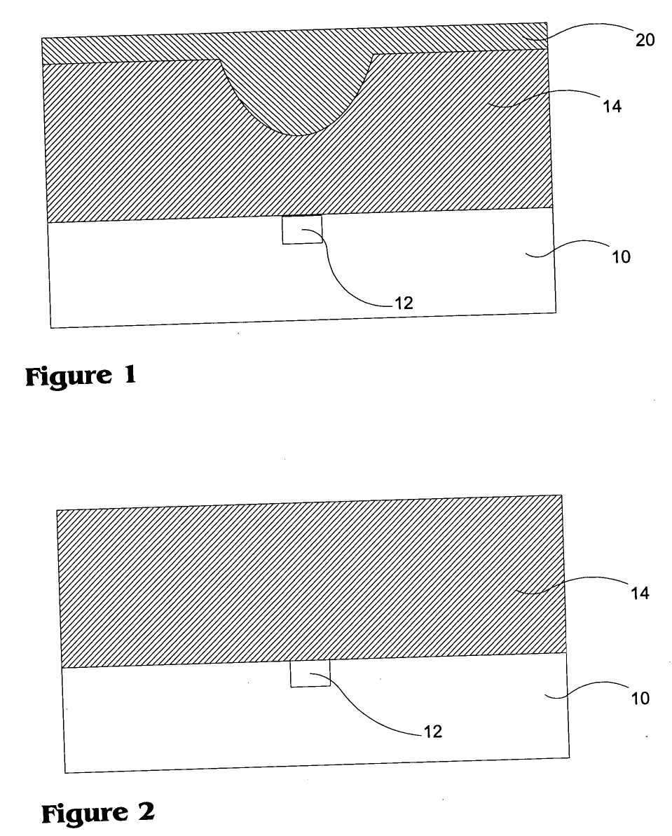

In one embodiment of the present process, microlenses 20 are formed overlying the photo-elements 12, eliminating the need to form the lenses and then transfer them to the substrate. Accordingly, a substrate having the desired photo-elements 12 formed on the substrate is prepared. FIG. 2 shows a substrate 10 having photo-elements 12 for sensing light with a transparent layer 14 overlying the pixels. In alternative embodiments, the lenses may be formed separately, for example as a sheet of microlenses, and placed overlying the photo-elements 12.

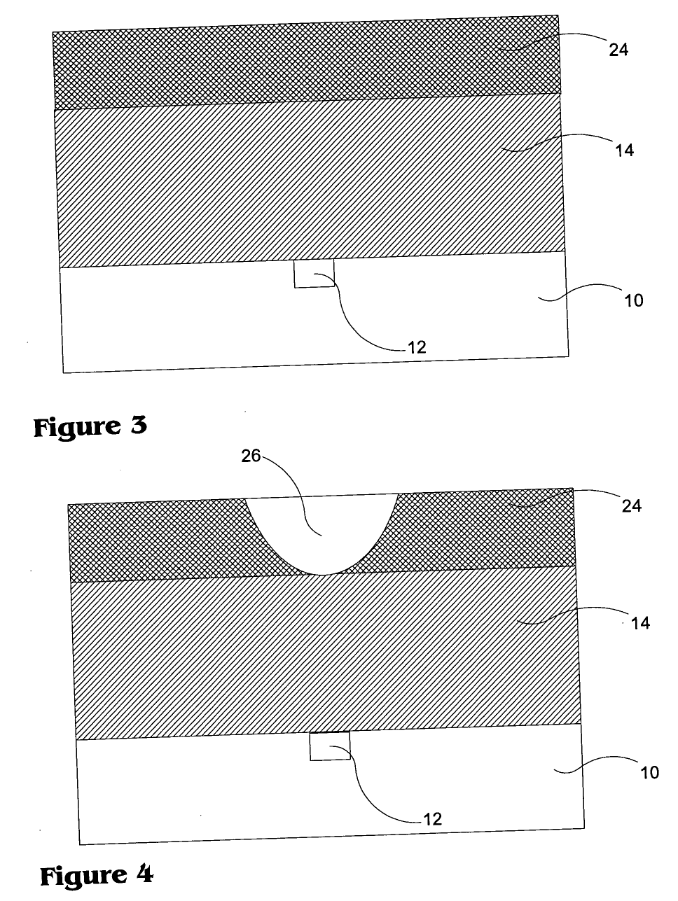

FIG. 3 shows a layer of photoresist 24 deposited overlying the transparent layer 14. An optional reflection control layer (not shown) may be interposed between the layer of photoresist 24 and the transparent layer 14. The details of the reflection control layer are shown and described in greater detail below. The layer of photoresist 24 is exposed through a mask with the basic shape of a desired lens area, for example a circle. By determining the response space for the desired resist profile, the layer of photoresist 24 can be exposed such that following developing a lens-shaped region is produced. Among the variables that can affect the response space are focus, exposure, reticle size, develop time, develop temperature, photoresist contrast, and whether the photoresist is negative resist or positive resist. The photoresist contrast is sometimes referred to as photoresist gamma. The photoresist contrast is a function of the resist selected and may be adjusted by developing conditions including for example the post exposure bake (PEB). Although the photoresist contrast, or gamma, is not necessarily known for any given photoresist, one of ordinary skill in the art may choose one photoresist over another based upon empirical knowledge of their relative photoresist contrast characteristics. By adjusting these variables, a resist profile suitable for use as a lens may be obtained.

FIG. 4 shows the layer of photoresist following exposure and developing. A lens-shaped region 26 is formed. In this example, positive photoresist is used so the lens-shaped region 26 is formed as an indentation in the photoresist layer 14. If a circular mask is used the lens-shaped region 26 may approximate either a spherical lens or an aspherical lens, for example the lens-shaped region 26 may approximate a parabolic lens.

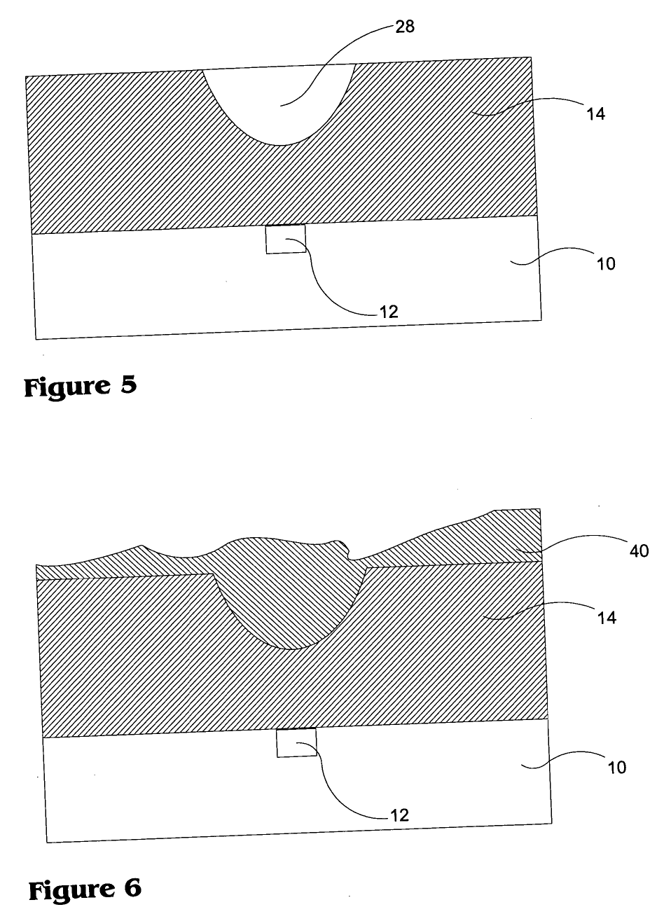

The lens-shaped region 26 is then transferred into the underlying transparent layer 14 to produce a lens-shaped region 28 in the transparent layer 14, as shown in FIG. 5. The lens-shaped region 26 may be transferred to the underlying transparent layer 14 using any suitable anisotropic etch. For example, a plasma etch with a power of 1,800 watts using 50 sccm CH₃F₈/10 sccm Ar may be used. Oxygen may also be added to assist in removing any unwanted polymer residues during the etch. If the etch ratio of the photoresist to the transparent layer 14 is 1:1 the lens-shaped region 26 is transferred such that the lens-shaped region 28 has essentially the same shape as the original lens-shaped region 26. If the etch ratio is not 1:1, the resulting lens-shaped region 28 will have a profile that is either more compressed or more elongated than the original lens-shaped region 26. This distortion during transfer may need to be accounted for to achieve a final desired lens-shaped region 28.

Once the lens shape 28 is formed, a lens material 40 is deposited to fill the lens shapes 28. The lens material may be deposited by a sputtering process, a CVD process, a spin-on process, or other suitable process. If a spin-on process is used, further smoothing of the upper planar surface may not be necessary. In this case, a lens 20 has been formed, producing the final structure shown in FIG. 1.

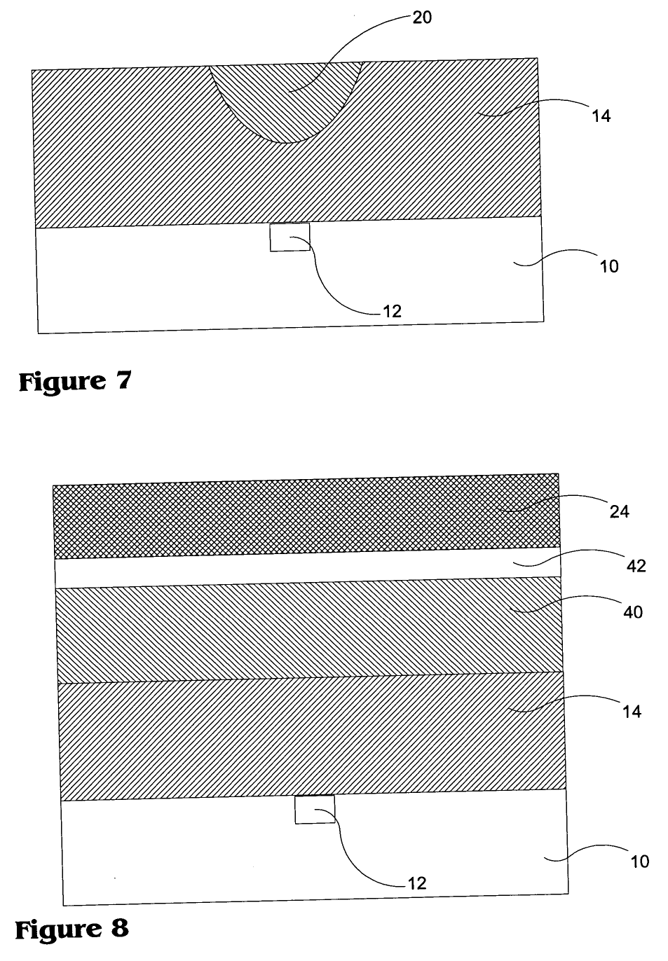

If the lens material 40 is rough, as shown in FIG. 6, a planarizing step is performed. In an embodiment of the present method, a CMP process is used to planarize the lens material 40. Alternatively, a reflow process is used to achieve planarization of the lens material 40. The amount of planarizing is not critical as long as enough of each lens 20 remains to achieve improved light collection, as shown in FIG. 7.

Referring again to FIG. 1, the substrate may be composed of any suitable material for forming or supporting a photo-element 12. For example in some embodiments, the substrate 10 is a silicon substrate, an SOI substrate, quartz substrate, or glass substrate.

In an embodiment of the present microlens structure, wherein it is desirable to concentrate light onto the photo-element 12, the transparent layer 14 will have a lower refractive index than each microlens 20. For example, if the transparent layer 14 has a refractive index of approximately 1.5, the microlenses 20 should have a refractive index equal to or greater than approximately 2. If the transparent layer 14 is silicon dioxide or glass, the microlens 20 may preferably be composed of HfO₂, TiO₂, ZrO₂, ZnO₂, or other lens material with a refractive index of approximately 2 or higher.

The thickness of the transparent layer 14 will be determined, in part, based on the desired lens curvature and focal length considerations, as well as the amount of etching caused by the anisotropic etch used to transfer the photoresist profile into the transparent layer 14. In one embodiment of the present microlens structure, the desired focal length of the microlenses 20 is between approximately 2 μm and 8 μm. The thickness of the transparent layer 14 as deposited should be thick enough to achieve the desired focal length distance following all etching and planarization steps.

FIG. 8 illustrates another embodiment of the present method. A layer of lens material 40 is deposited overlying the transparent layer 14. A layer of photoresist 24 is deposited overlying the lens material 40. An optional reflection control layer 42 is interposed between the layer of photoresist 24 and the lens material 40. The reflection control layer 42 may be for example a layer of material with a relatively constant reflection across its surface, such as titanium. Alternatively, the reflection control layer 42 may be a material that absorbs light such as titanium nitride. In another embodiment, the reflection control layer 42 may be a bottom anti-reflection coating material, which is referred to herein as a BARC material. The BARC material may have properties that are similar to that of the photoresist, for example the BARC material may have an etch rate that is the same as that of the photoresist. For example, ARC I-CON™-16, which is a composition of propylene glycol monomethyl ether acetate (20-40%) and Ethyl lactate (60-80%) along with proprietary crosslinking agents (0-2%) and polymer solids (2-10%), supplied by Brewer Science, Inc is an available BARC material. The reflection control layer 42 reduces, or eliminates, reflections from underlying structures related to the photo-element 12, such as wiring or other features, that might adversely affect the exposure of the photoresist. The presence of these undesirable reflections may distort the resulting lens shape. The layer of photoresist 24 is exposed to sensitize a lens-shaped region. To sensitize a lens-shaped region means that an aerial image is formed at the photoresist during exposure and that following developing a lens-shaped region is produced at that location within the resist.

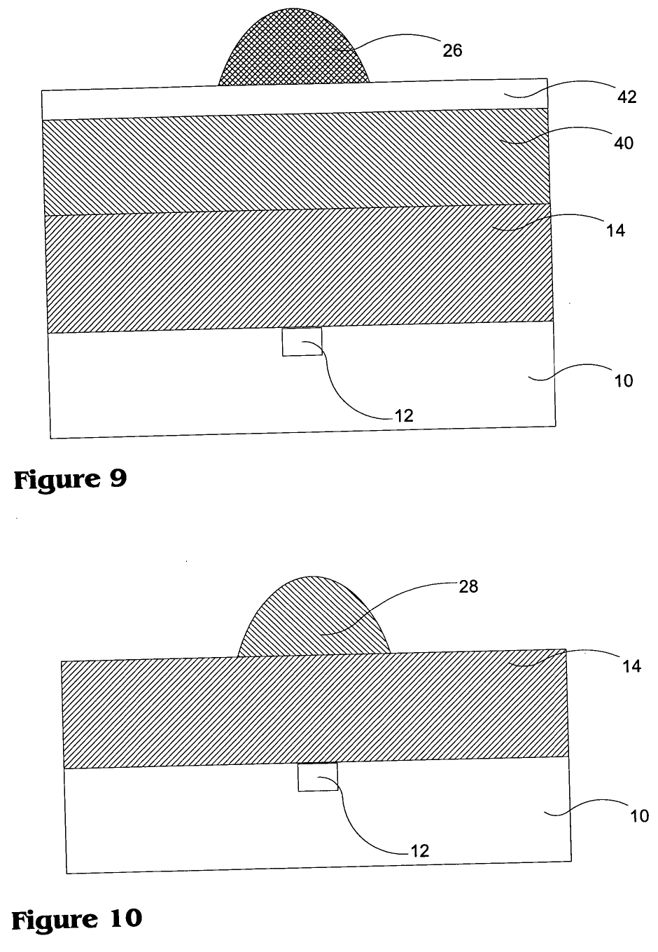

FIG. 9 shows the layer of photoresist following exposure and developing. A lens-shaped region 26 is formed. In this example, negative photoresist is used so the lens-shaped region 26 is formed as a protrusion formed by the remainder of the photoresist layer after developing. If a circular mask is used the lens-shaped region 26 may approximate either a spherical lens or an aspherical lens, for example the lens-shaped region 26 may approximate a parabolic lens.

The lens-shaped region 26 is then transferred into the underlying layer of lens material 40 to produce a lens-shaped region 28, as shown in FIG. 10. The lens-shaped region 26 may be transferred to the layer of lens material 40 using any suitable anisotropic etch. For example, if a TiO₂ lens material is used, a plasma etch with a power of 400 watts using 35 sccm Cl₂/20 sccm BCl₃/35 sccm HBr may be used. Oxygen may also be added to assist in removing any unwanted polymer residues during the etch. If the etch ratio of the photoresist to the layer of lens material 40 is 1:1 the lens-shaped region 26 is transferred such that the lens-shaped region 28 has essentially the same shape as the original lens-shaped region 26. If the etch ratio is not 1:1, the resulting lens-shaped region 28 will have a profile that is either more compressed or more elongated than the original lens-shaped region 26. This distortion during transfer may need to be accounted for to achieve a final desired lens-shaped region 28.

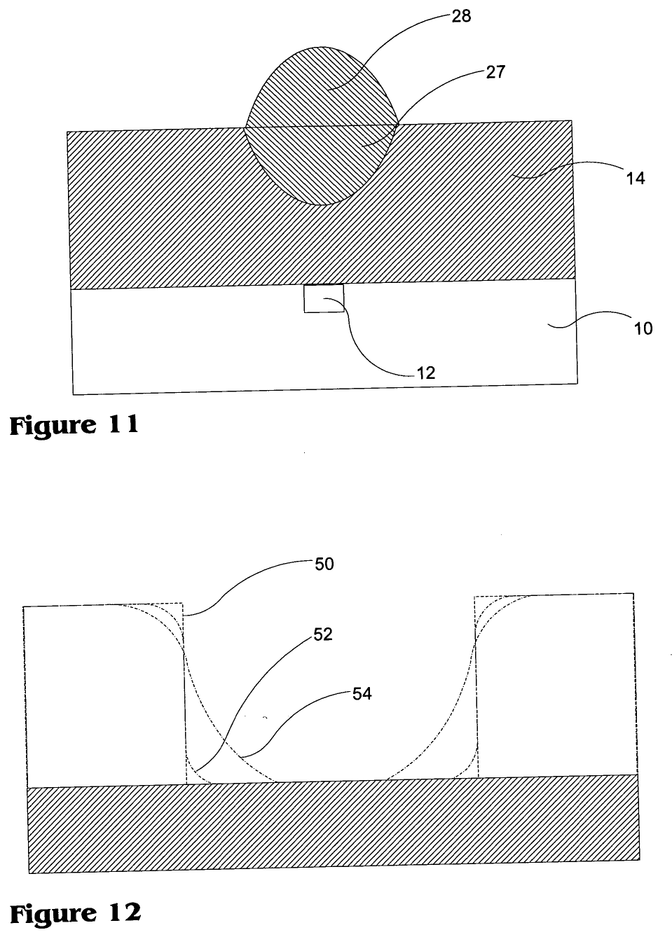

FIG. 11 shows a lens-shaped region 28 produced by depositing the layer of lens material 40 over a previously formed lens-shaped region 27, and then processing to produce the lens-shaped region 28. This enables the formation of a convex-convex lens structure.

FIG. 12 shows photoresist profiles following patterning using, for example, a circular mask opening. Ideal profile 50 shows a pattern formed having vertical sidewalls such that the pattern has been transferred without distortion. A more typical profile 52 has some distortion at the edges, due to a variety of issues associated with imaging a pattern onto photoresist as is well known in the art. These distortions are generally considered undesirable. The lens-shaped profile 54 would be considered to have even more distortion from the ideal case shown in profile 50 than profile 52. In the present method, this previously undesirable effect is being exploited to produce a profile 54 that corresponds to a lens shape.

As discussed above, some of the variables that can affect the response space are focus, exposure, reticle size, develop time, develop temperature, photoresist contrast, and whether the photoresist is negative resist or positive resist. By adjusting these variables, a resist profile suitable for use as a lens may be obtained. These variables can be grouped into exposure and processing groups. The variables of focus, exposure and reticle design relate to the exposure group. These variables all affect the aerial image, which is the image of the reticle that is projected onto the photoresist by an optical system, at the photoresist layer. The focus variable adjusts the contrast of the aerial image at the pattern edge. The exposure adjusts the pattern size of the final photoresist pattern laterally. The reticle design takes into consideration the overall pattern of the object as to proximity effects.

The variables of develop time, develop temperature, photoresist contrast, PEB conditions, and tone of the photoresist (positive or negative) can be grouped together as processing parameters. The variables all relate to the photoresist directly and can be considered apart from the aerial image. The develop time, in combination with the develop temperature and the PEB adjusts the photoresist contrast and the resulting photoresist profile. The tone of the photoresist adjusts the removal or non-removal of the photoresist after exposure to light.

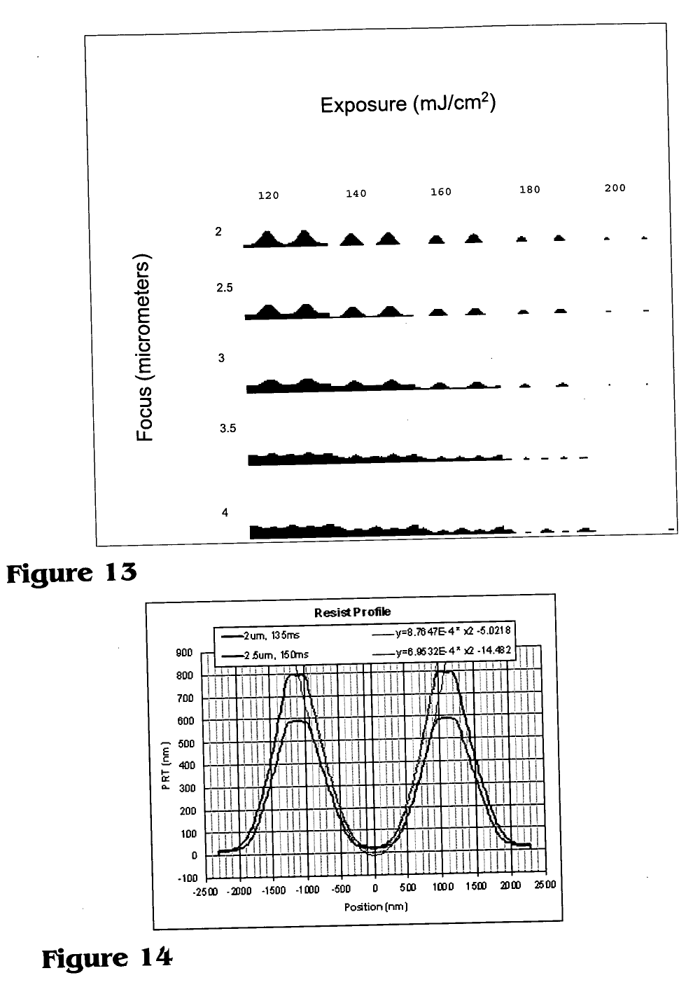

By fixing some of the variables and adjusting others it is possible to control the resulting photoresist profile. For example, the processing parameters, and the reticle design can be fixed and the focus and exposure varied to determine the proper conditions for producing a desired lens-shaped profile. The effect of changing the focus and the exposure may be studied by processing sample wafers. Alternatively, a simulation package such as Prolith™ may be used to simulate the effects of changing focus and exposure, as well as other parameters. FIG. 13 shows a focus/exposure matrix of the resulting photoresist profile created using Prolith™. By reviewing the matrix, a focus of between 1.5 μm and 3.5 μm with an exposure between 100 mJ/cm² and 160 mJ/cm² will likely produce photoresist profiles suitable for forming a lens. An SPR500 positive resist was used for the purpose of the model used to produce the matrix shown in FIG. 13. The exposure may vary depending on the photoresist selected.

FIG. 14 illustrates two different photoresist profiles. One profile used 2 μm defocus at an exposure of 135 ms, while the second profile was achieved using a 2.5 μm defocus at an exposure of 150 ms. A parabola has been fit to each profile for comparison. Based upon the fits, the resulting photoresist profile approximates a parabola. Even though it deviates from a parabola at the bottom of the profile, it is possible to treat the resulting lens as a parabolic lens.

As discussed above, the process may be used to produce lens shapes using either positive photoresist, or negative photoresist. For example, a lens-shaped photoresist profile may be produced using a positive resist, such as JSR IX715DM7. The photoresist is deposited to a thickness of approximately 1.2 μm. A softbake is performed at approximately 97° C. for approximately 1 minute. A mask pattern of a circular opening that will produce an approximately 2 μm diameter pattern at the wafer surface is used with a defocus of approximately 2 μm to expose the photoresist for a 450 ms, to achieve an approximately 200 mJ/cm² exposure. For the aligner used in these examples, which was a NIKON® NSR1505I7 Aligner, the mask pattern will be approximately five times the size of the pattern at the wafer surface. A post exposure bake is then performed at approximately 110° C. for approximately 1 minute, followed by developing for approximately 1 minute at room temperature using PD523AD developer, which is a TMAH-based aquesous developer. A hardbake at approximately 110° C. for approximately 1 minute completes the developing process. The resulting lens-shaped photoresist profile may then be used as described above to form a plano-convex lens overlying a substrate.

In another example, a lens-shaped photoresist profile may be produced using a negative resist, such as JSR NFR103G. The photoresist is deposited to a thickness of approximately 1.0 μm. A softbake is performed at approximately 97° C. for approximately 1 minute. A mask pattern of a circular opening that will produce an approximately 2 μm diameter pattern at the wafer surface is used with a defocus of approximately 2 μm to expose the photoresist for a 350 ms to achieve an approximately 150 mJ/cm² exposure. For the aligner used in these examples, the mask pattern will be approximately five times the size of the pattern at the wafer surface. A post exposure bake is then performed at approximately 110° C. for approximately 1 minute, followed by developing for approximately 1 minute at room temperature using PD523AD developer. A hardbake at approximately 110° C. for approximately 1 minute completes the developing process. The resulting lens-shaped photoresist profile may then be used as described above to form a convex-plano lens overlying a substrate.

For the above examples, a binary reticle of Cr/CrO on Quartz may be used. Alternatively, a phase shifting reticle with optical proximity correction (OPC) features may be used. The size of the pattern formed by the reticle on the wafer may have a diameter of approximately 10 μm. For certain CCD applications, a lens diameter of between 1 μm and 3 μm may be used. For LCD applications, a lens diameter in excess of 10 μm may be achieved by increasing the defocus to greater than 10 μm defocus.

The terms of relative position, such as overlying, underlying, beneath are for ease of description only with reference to the orientation of the provided figures, as the actual orientation during, and subsequent to, processing is purely arbitrary.

Although embodiments, including certain preferred embodiments, have been discussed above, the coverage is not limited to any specific embodiment. Rather, the claims shall determine the scope of the invention.

What is claimed is:

1. A method of forming a microlens structure comprising:
depositing a photoresist layer overlying a material;
exposing the photoresist layer using a predetermined focus and exposure to sensitize a lens-shaped region within the photoresist layer;
developing the photoresist to form a lens-shaped region within the photoresist layer; and
transferring the lens-shaped region from the photoresist layer to the material.

2. The method of claim 1, wherein the photoresist layer is a positive photoresist and the material is a transparent material.

3. The method of claim 1, wherein the predetermined focus is between 1 μm and 5 μm defocused.

4. The method of claim 3, wherein the predetermined focus is between 2 μm and 3 μm defocused.

5. The method of claim 2, wherein the predetermined focus is between 1 μm and 5 μm defocused.

6. The method of claim 5, wherein the predetermined focus is between 2 μm and 3 μm defocused.

7. The method of claim 1, further comprising depositing a lens material overlying the transparent material after transferring the lens-shaped region from the photoresist layer to the transparent material.

8. The method of claim 7, wherein the lens material has a higher refractive index than the transparent material.

9. The method of claim 8, wherein the transparent material comprises silicon dioxide or glass.

10. The method of claim 8, wherein the lens material comprises HfO₂, TiO₂, ZrO₂, or ZnO₂.

11. The method of claim 7, further comprising planarizing the lens material.

12. The method of claim 1, wherein the photoresist layer is a negative photoresist and the material is a lens material.

13. The method of claim 12, wherein the predetermined focus is between 1 μm and 5 μm defocused.

14. The method of claim 13, wherein the predetermined focus is between 2 μm and 3 μm defocused.

15. The method of claim 12, wherein the lens material comprises HfO₂, TiO₂, ZrO₂, or ZnO₂.

16. The method of claim 1, further comprising depositing a reflection control layer overlying the material prior to depositing the photoresist layer.

17. The method of claim 16, wherein the reflection control layer is titanium.

18. The method of claim 16, wherein the reflection control layer is titanium nitride.

19. The method of claim 16, wherein the reflection control layer is a BARC material.

20. The method of claim 1, further comprising a photoelement located beneath the material.

21. The method of claim 20, wherein the photoelement is a CCD pixel.

22. The method of claim 20, wherein the photoelement is an LCD pixel.

23. A method of forming a microlens structure comprising:
producing a lens-shaped region within a photoresist layer by exposing the photoresist layer using a defocused mask image and developing the photoresist layer;
transferring the lens-shaped region from the photoresist layer to an underlying transparent material; and
depositing a lens material overlying the transparent material to fill the lens-shaped region.

24. A method of forming a microlens structure comprising:
producing a lens-shaped region within a photoresist layer by exposing the photoresist layer using a defocused mask image and developing the photoresist layer; and
transferring the lens-shaped region from the photoresist layer to an underlying lens material.

25. The method of claim 24, further comprising providing a reflection control layer interposed between the photoresist layer and the underlying lens material.

26. The method of claim 25, wherein the reflection control layer comprises a reflective material.

27. The method of claim 25, wherein the reflective material is titanium.

28. The method of claim 25, wherein the reflection control layer comprises a light absorbing material.

29. The method of claim 25, wherein the reflection control material is titanium nitride.

30. The method of claim 25, wherein the reflection control material is a BARC material.

31. A method of forming a microlens structure comprising:
producing a first lens-shaped region within a photoresist layer by exposing the photoresist layer using a defocused mask image and developing the photoresist layer;
transferring the first lens-shaped region from the photoresist layer to an underlying transparent material;
depositing a lens material overlying the transparent material to fill the first lens-shaped region, whereby a first microlens structure is formed;
depositing layer of lens material overlying the first microlens structure;
depositing a photoresist layer overlying the layer of lens material;
producing a second lens-shaped region within the photoresist layer by exposing the photoresist layer using a defocused mask image and developing the photoresist layer; and
transferring the second lens-shaped region from the photoresist layer to the layer of lens material, whereby a second microlens structure is formed overlying the first microlens structure.
